(19) United States
(12) Patent Application Publication
(10) Pub. No.: US 2006/0201995 A1
(43) Pub. Date: Sep. 14, 2006

(54) BORE ALIGNMENT TOOL

(75) Inventors: Paul S. Gopalan, Houston, TX (US); Gary Gene Bender, Houston, TX (US)

Correspondence Address: CONLEY ROSE, P.C., P. O. BOX 3267, HOUSTON, TX, 77253-3267, US

(73) Assignee: DANIEL INDUSTRIES, INC., Houston, TX (US)

(21) Appl. No.: 10/906,848

(22) Filed: Mar. 9, 2005

(51) Int. Cl. B23K 37/00

(52) U.S. Cl. 228/44.5

(57) ABSTRACT

Apparatus and methods for aligning tubular members comprising a first and second expandable member coupled to a rod. A first expandable member is disclosed that moves in an axial direction toward the second expandable member. The first expandable member engages a first tubular member and the second expandable member engages a second tubular member. After alignment, the first tubular member is concentric with the second tubular member and an end of the first tubular member is adjacent to an end of the second tubular member.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

The present invention relates generally to methods and apparatus for aligning and centering tubular members such as pipes and flanges. More particularly, the present invention relates to positioning tubular members in preparation for fabrication procedures such as welding or grinding.

Before two tubular members can be welded together, the members should be aligned so that they are concentric with each other and the end of one member is flush with the end of the opposing member. Aligning the tubular members in this manner will minimize any space or gaps between the members and lead to improved weld quality and efficiency.

In order to align tubular members concentrically, it is necessary to impart forces on the tubular members that are perpendicular to the primary axis of the member. In order to position the tubular members so that the end of one member is flush with the opposing end of the second member, it is necessary to impart forces on the members that are parallel to the primary axis of the members. This need to impart forces in different directions generally leads to increased complexity in the design of alignment devices. In addition, any alignment device that is disposed on the outside of the tubular members can restrict access to the interface between the ends of the tubular members. This increases the difficulty of performing the fabrication step, such as welding or grinding, that is being performed on the tubular members. It is therefore desired to have an alignment device which imparts forces on the tubular members necessary to align them concentrically and to position the ends of each member so that they are adjacent to each other. It is further desired to have an alignment device which can accomplish this without restricting access to the interface between the two ends.

In addition, the dimensions of tubular members (such as the inner and outer diameters) have a tolerance range and therefore vary from one component to the next. This reduces the ability of fixed dimension mandrels or jigs to properly align two tubular members that do not have identical dimensions. It is therefore desired to have an alignment device which compensates for the variations in dimensions between tubular members and effectively aligns tubular members with different dimensions.

Thus, there remains a need to develop methods and apparatus for aligning tubular members which overcome some of the foregoing difficulties while providing more advantageous overall results.

### SUMMARY OF THE PREFERRED EMBODIMENTS

The embodiments of the present invention are directed toward methods and apparatus for aligning tubular members. More specifically, embodiments of the present invention comprise a first and second expandable member coupled to a rod, wherein the first expandable member moves in an axial direction toward the second expandable member. In embodiments of the present invention, the first expandable member engages a first tubular member and the second expandable member engages a second tubular member. After alignment according to embodiments of the present invention, the first tubular member is concentric with the second tubular member and an end of the first tubular member is adjacent to an end of the second tubular member.

Thus, the present invention comprises a combination of features and advantages that enable it to overcome various problems of prior devices. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of the preferred embodiment of the present invention, reference will now be made to the accompanying drawings, wherein:

FIG. 1 is a section view of one embodiment of an alignment apparatus;

FIG. 2 is a section view of one embodiment of an alignment apparatus;

FIG. 3 is a partial sectional view of one embodiment of an alignment apparatus; and

FIG. 4 is a partial section view of one embodiment of an alignment apparatus.

### DETAILED DESCRIPTION OF THE PREFERRED EMBODIMENTS

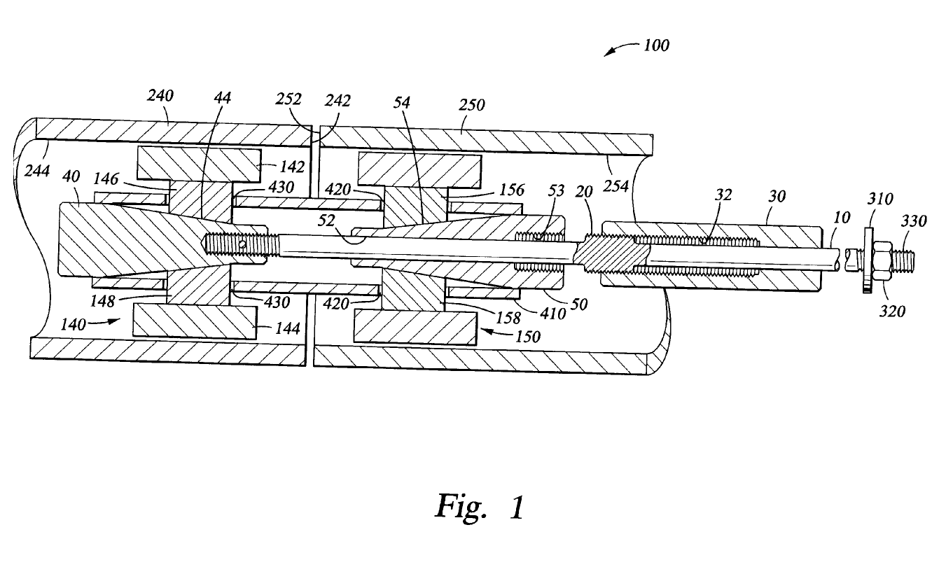

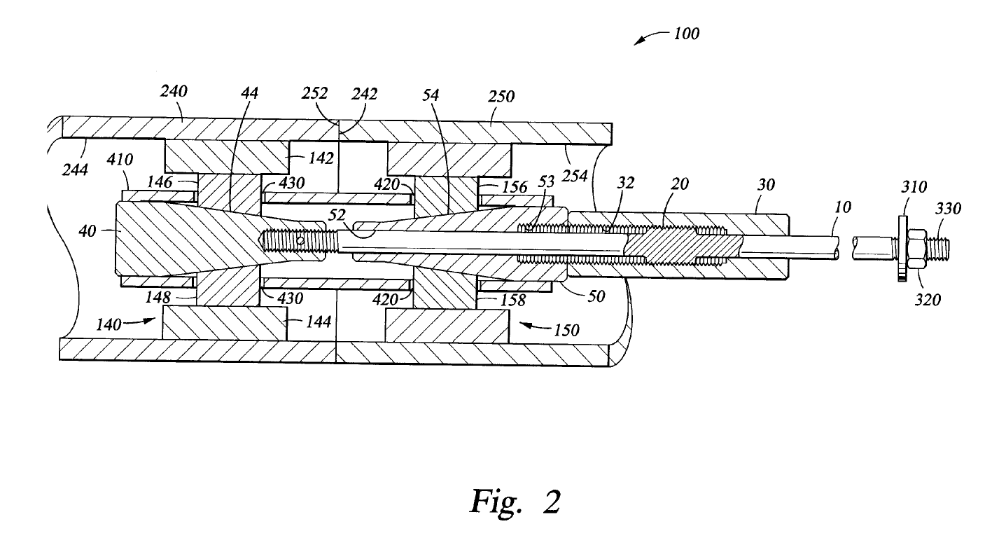

Referring now to FIGS. 1 and 2, an alignment apparatus 100 is comprised of a rod 10 with a threaded portion 20. Rod 10 is coupled to a first tapered member 40 and rod 10 is disposed through a second tapered member 50 with a bore 52 and a tapered portion 54. An elongated member 30 is disposed around rod 10 such that second tapered member 50 is between first tapered member 40 and elongated member 30. Elongated member 30 further comprises a threaded bore 32. First tapered member 40 comprises a tapered portion 44 and is disposed within first expandable member 140, which is further disposed within tubular member 240. Second tubular member 50 is disposed within first expandable member 150, which is further disposed within tubular member 250. An elongated spacer 410 with slots 420 and 430 is disposed between expandable members 140 and 150. In FIG. 1, alignment apparatus 100 has been inserted into tubular members 240 and 250, but the process of aligning tubular members 240 and 250 has not begun. In FIG. 2, the alignment process has been completed.

Alignment apparatus 100 is operated by threadably engaging threaded bore 32 of elongated section 30 with threaded portion 20 of rod 10. As elongated section 30 is rotated about threaded portion 20 of rod 10, elongated section 30 is advanced towards second tapered member 50. As shown in FIG. 2, after sufficient advancement, elongated section 30 makes contact with second tapered member 50 and pushes second tapered member 50 towards first tapered member 40. Initially, tapered member 50 will push expandable member 150 towards first tapered member 40. As expandable member 50 moves axially, tabs 156 and 158 engage slots 420 in elongated spacer 410.

After slots 420 are engaged, further advancement of elongated member 30 will cause second tapered member 50 to move axially relative to tabs 156 and 158 of second expandable member 150. This will cause second expandable member 150 to expand radially until it engages inner surface 254 of second tubular member 250. When second tubular member 250 restricts further expansion of second expandable member 150, second expandable member 150 is considered “locked” or coupled to second tubular member 250.

Further rotation of elongated member 30 relative to rod 10 will cause threaded portion 20 of rod 10 to advance farther into threaded bore 32 and away from second expandable member 150. This advancement of threaded portion 20 causes rod 10 to slide through bore 52 of second tapered member 50. Because rod 10 is coupled to first tapered member 40, the movement of threaded portion 20 and rod 10 pulls first tapered member 40 closer to second tapered member 50. The movement of first tapered member 40 in this direction causes first expandable member 140 to expand until first expandable member 140 contacts first tubular member 240. While a threaded connection is shown in the embodiment of FIGS. 1 and 2, other means of coupling rod 10 to first tapered member 40 may be used in other embodiments of the invention. First expandable member 140 is considered “locked” or coupled to first tubular member 240 when first tubular member 240 prevents further expansion of first expandable member 140. At this point, first tubular member 240 is concentric to second tubular member 250 because both members are centered about rod 10.

In certain embodiments of the present invention, contact members 142 and 144 of first expandable member 140 can be made of a material such as brass that is softer than first tubular member 240. Constructing contact members 142 and 144 of such material would minimize the risk of damage to an inner surface 244 of first tubular member 240. Use of softer materials for contact members 142 and 144 would be important where there is a need to maintain smooth surface finishes for surfaces 244 and 254.

A benefit of the embodiment shown in FIGS. 1 and 2 is that first expandable member 140 and second expandable member 150 are capable of expanding independently of each other. For example, first tapered member 40 may move relative to first expandable member 140 (and thus expand first expandable member 140) even if second expandable member 150 is restrained from further expansion by second tubular member 250. Similarly, second tapered member 50 can expand second expandable member 150 even if first expandable member 140 is restrained from further expansion by first tubular member 240. This benefit is most evident if first tubular member 240 and second tubular member 250 do not have equal internal diameters.

Typically, in prior art devices a single expandable member extended between the two tubular members to be aligned. With such devices, it is difficult to ensure the expandable member positively engages both tubular members if the internal diameters of the tubular members are not equal. If one tubular member has a smaller internal diameter than the other tubular member, the smaller diameter will prevent the expandable member from engaging the larger tubular member and ensuring proper alignment.

However, in the embodiment of the present invention shown in FIG. 2, alignment apparatus 100 can align first tubular member 240 to second tubular member 250 even if inner surface 244 is a different diameter than inner surface 254. Alignment of different diameter tubular members can be accomplished because first expandable member 140 and second expandable member 150 can expand independently of each other. Therefore, each expandable member will be capable of expanding until it engages its respective tubular member and will not be restrained from expanding by the engagement of the opposing expandable member with its respective tubular member.

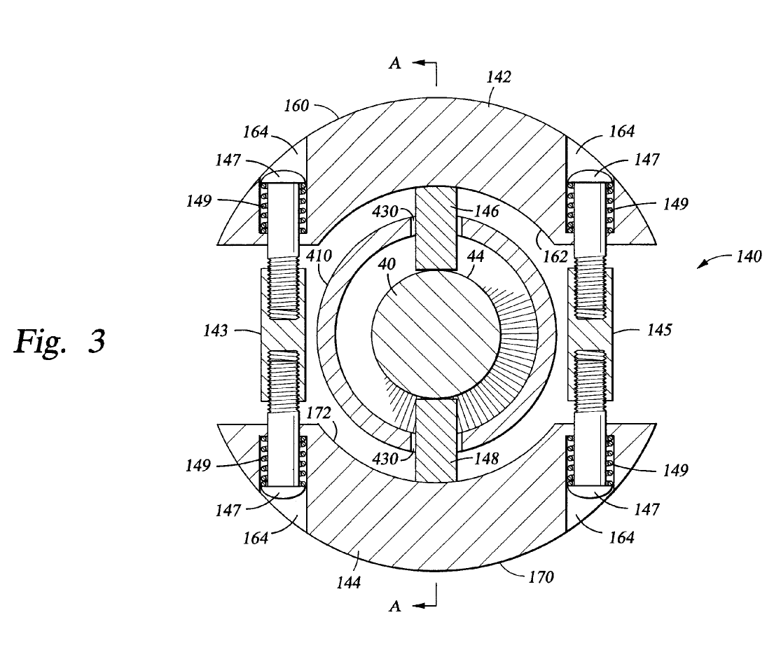

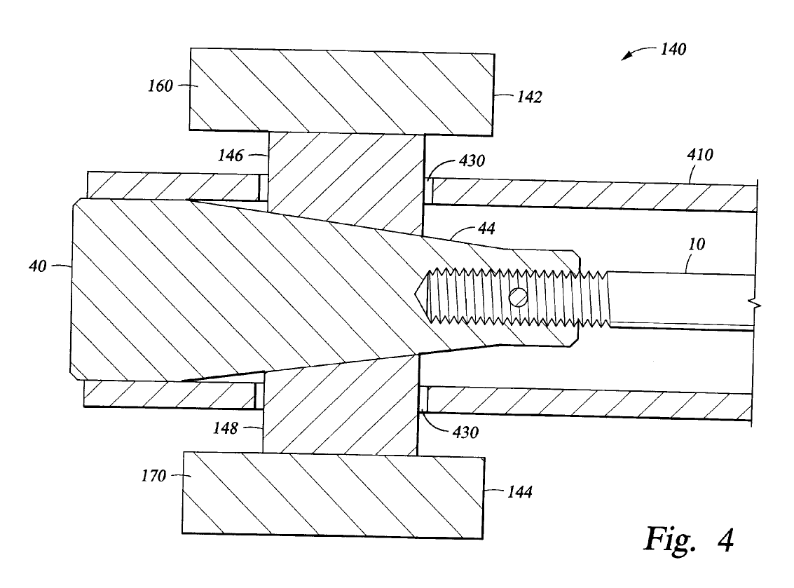

Referring now to FIGS. 3 and 4, a more detailed view of the interrelation between first tapered member 40 and the other components in first expandable member 140 is shown in one embodiment. The interrelation between second tapered member 50 and second expandable member 150 operates in a similar manner to that shown in FIGS. 3 and 4, and is therefore not shown in separate figures. In the cross-section end view of FIG. 3, first expandable member 140 is shown to comprise several individual components in addition to first tapered member 40. In this embodiment, contact member 142 is shown to have a generally curved shape that includes outer surface 160 and inner surface 162. However, other embodiments may include contact members with different shapes. Contact member 142 also includes a tab 146 that engages a slot 430 in elongated spacer 410. Similarly, first expandable member 140 includes a contact member 144 that includes an outer surface 170, an inner surface 172, and a tab 148 that engages a slot 430 in elongated spacer 410. As shown in the embodiment in FIG. 3, contact members 142 and 144 further comprise a plurality of countersunk holes 164. Disposed within holes 164 are springs 149 and bolts 147. Although coil springs are shown in the embodiment in FIG. 3, other types of springs may be used. For example, springs or other tensioning members that circumscribe outer surfaces 160 and 170 may be used to keep tabs 146 and 148 in contact with tapered surface 44 of first tapered member 40.

In the embodiment shown in FIG. 3, bolts 147 extend through contact members 142 and 144 and are threadably engaged with support members 143 and 145. Springs 149 act on bolts 147 and the bottom surfaces of countersunk holes 164 to keep tabs 146 and 148 in contact with slots 164 and 174. This allows first expandable member 140 to be assembled onto first tapered member 40 prior to being inserted in a tubular member.

Referring now to FIG. 4, a cross-section is shown which has been taken along the A-A plane in FIG. 3. As shown in FIG. 4, tabs 146 and 148 are angled at approximately the same angle as tapered portion 44 of first tapered member 40. Therefore, as first tapered member 40 moves to the right in FIG. 4 (relative to first expandable member 140), contact members 142 and 144 will be forced farther away from each other, or expanded in a radial direction. This enables outer surfaces 160 and 170 to contact the inner surface of a tubular member (not shown). Referring back now to FIG. 3, the expansion of first expandable member 140 (through the movement of contact members 142 and 144) causes springs 149 to compress. As previously mentioned, springs 149 allow first expandable member 140 and first tapered member 40 to be assembled as a unit by keeping contact members 142 and 144 in contact with tapered member 40. This results in a simple and efficient method of installation. The ability to compress springs 149 also allows first expandable member 140 to be expanded after it has been inserted into a tubular member.

As shown in FIG. 2, after the alignment process has been completed, tubular members 240 and 250 are concentric and ends 242 and 252 are adjacent to each other. After the desired manufacturing processes performed, alignment apparatus 100 may be easily removed from tubular members 240 and 250. Beginning with alignment apparatus in the configuration shown in FIG. 2, elongated member 30 is rotated relative to rod 10 so that elongated member moves away from second tapered member 50. After sufficient rotation, elongated member 30 will become disengaged from threaded portion 20 of rod 10. At this point, end 330 of rod 10 can be gently tapped in the direction of first tapered member 40. This will cause tapered member 40 to move relative to first expandable member 140, thereby allowing first expandable member 140 to retract or collapse so that it is no longer “locked” or attached to first tubular member 240.

After first expandable member 140 has been released, rod 10 can be pushed towards second expandable member 50 so that threaded portion 20 is adjacent to threaded bore 53. Rod 10 can then be rotated to that threaded portion 20 is threadably engaged with threaded bore 53 of second tapered member 50. At this point, elongated member 30, which is no longer threadably engaged with threaded portion 20, can be tapped against a washer 310 that is secured to rod 10 with a nut 320. Because nut 320 secures washer 310 to rod 10, the impact of elongated member 30 against washer 310 will disengage second tapered member 50 from first expandable member 150. This will release second expandable member 150 from second tubular member 250 and allow alignment apparatus 100 to be removed from tubular members 240 and 250.

While preferred embodiments of this invention have been shown and described, modifications thereof can be made by one skilled in the art without departing from the scope or teaching of this invention. The embodiments described herein are exemplary only and are not limiting. Many variations and modifications of the system and apparatus are possible and are within the scope of the invention. For example, the relative dimensions of various parts, the materials from which the various parts are made, and other parameters can be varied, so long as the alignment apparatus retain the advantages discussed herein. Furthermore, the sequential recitation of steps in any claims is not a requirement that the steps be performed in any particular order, unless otherwise so stated. Accordingly, the scope of protection is not limited to the embodiments described herein, but is only limited by the claims that follow, the scope of which shall include all equivalents of the subject matter of the claims.

What is claimed is:

1. An apparatus for aligning tubular members comprising:
a rod;
a first expandable member coupled to said rod; and
a second expandable member coupled to said rod, wherein said first expandable member is capable of expanding independently of said second expandable member.

2. The apparatus of claim 1 wherein said first expandable member engages a first tubular member and said second expandable member engages a second tubular member.

3. The apparatus of claim 2 wherein an inner diameter of said first tubular member is not equal to an inner diameter of said second tubular member.

4. The apparatus of claim 3 wherein said first expandable member continues to expand after said second tubular member restrains said second expandable member.

5. The apparatus of claim 3 wherein said second expandable member continues to expand after said first tubular member restrains said first expandable member.

6. The apparatus of claim 1 further comprising:
an elongated member, wherein said elongated member engages said first or said second expandable member and causes said first or said second expandable member to expand in a radial direction.

7. The apparatus of claim 6 wherein said elongated member is threadably engaged with said rod.

8. The apparatus of claim 1 further comprising:
a spacer disposed between said first and second expandable members.

9. The apparatus of claim 8 wherein said spacer comprises a plurality of slots and said first and second expandable members engage said plurality of slots.

10. An apparatus for aligning tubular members comprising:
a rod with a threaded portion;
an elongated member threadably engaged with said threaded portion of said rod;
a first tapered member coupled to said rod;
a second tapered member, wherein said second tapered member is disposed on said rod;
a first expandable member coupled to said first tapered member;
a second expandable member coupled to said second tapered member; and
a spacer between said first and said second expandable members.

11. The apparatus of claim 10 wherein:
said elongated member comprises an internally threaded bore.

12. The apparatus of claim 10 wherein:
said first expandable member is disposed within a first tubular member and said second expandable member is disposed within a second tubular member.

13. The apparatus of claim 10 wherein:
rotation of said elongated member about said threaded portion of said rod causes said elongated member to engage said second tapered member.

14. The apparatus of claim 13 wherein:
further rotation of said elongated member causes said second tapered member to expand said second expandable member until said second expandable member is engaged by said second tubular member.

15. The apparatus of claim 13 wherein:
further rotation of said elongated member causes said first tapered member to expand said first expandable member until said first expandable member is engaged by said first tubular member.

16. The apparatus of claim 15 wherein:
said first tubular member is concentric to said second tubular member.

17. A method of aligning a first tubular member to a second tubular member comprising the steps of:
inserting a rod through a second expandable member and coupling said rod to a first expandable member;
placing said first expandable member into said first tubular member;
placing said second expandable member into said second tubular member;
engaging an elongated member with said rod and said second expandable member;
expanding said second expandable member until said second expandable member is restrained by said second tubular member; and
expanding said first expandable member until said first expandable member is restrained by said first tubular member.

18. The method of claim 17 further comprising the steps of:
threadably engaging said elongated member with a threaded portion of said rod and rotating said elongated member so that said elongated member engages said second expandable member.

19. The method of claim 17 wherein:
said first expandable member positions said first tubular member so that said first tubular member is concentric with said second tubular member.

20. The method of claim 17 wherein:
said first expandable member comprises a first tapered member and said second expandable member comprises a second tapered member.
